(19) United States
(12) Patent Application Publication
(10) Pub. No.: US 2024/0210850 A1
(43) Pub. Date: Jun. 27, 2024

(54) IMAGE FORMING APPARATUS, NON-TRANSITORY COMPUTER READABLE MEDIUM AND IMAGE FORMING METHOD

(71) Applicant: FUJIFILM Business Innovation Corp., Tokyo (JP)

(72) Inventors: Shuhei YAMAZAKI, Kanagawa (JP); Yu TSUDA, Kanagawa (JP)

(73) Assignee: FUJIFILM Business Innovation Corp., Tokyo (JP)

(21) Appl. No.: 18/596,902

(22) Filed: Mar. 6, 2024

(30) Foreign Application Priority Data
Sep. 27, 2023 (JP) 2023-165880

(51) Int. Cl. G03G 15/01; G03G 15/00

(52) U.S. Cl. CPC G03G 15/0184; G03G 15/0121; G03G 15/50; G03G 15/55

(57) ABSTRACT

An image forming apparatus includes multiple image forming units that are arranged in one direction and form images by attaching developers to surfaces of image carriers and transfer the images onto recording media, the image forming units including a first image forming unit that forms an image of a developer of a first color on a surface of a first image carrier and a second image forming unit that is located downstream of the first image forming unit, forms an image of a developer of second color on a surface of a second image carrier and includes a contact member having a tip portion that contacts the surface of the second image carrier after the transferring, wherein the image forming apparatus performs at a predetermined frequency an operation that forms a predetermined image by attaching the developer of the second color to the surface of the second image carrier and causes the predetermined image on the surface of the second image carrier to pass between the surface of the second image carrier after the transferring and the tip portion of the contact member.

### CROSS-REFERENCE TO RELATED APPLICATIONS

This application is based on and claims priority under 35 USC 119 from Japanese Patent Application No. 2023-165880 filed Sep. 27, 2023.

### BACKGROUND

### (i) Technical Field

The present disclosure relates to an image forming apparatus, a non-transitory computer readable medium and an image forming method.

### (ii) Related Art

Japanese Unexamined Patent Application Publication No. 2019-78787 discloses a configuration including a maintenance module. The maintenance module forms on an image carrier a maintenance image of image forming charged particles using an imaging unit and rotates the image carrier with a transfer operation not performed by a transfer unit to cause the maintenance image to pass by a closing member periodically or non-periodically. The maintenance image used by the maintenance module includes multiple band-like images that extend continuously or non-continuously in an intersection direction perpendicular to the direction of the rotation of the image carrier. The band-like image has a concave-convex pattern at any location along the intersection direction of the image carrier. The concave-convex pattern includes multiple convex portions spaced apart by intervals in the rotation direction of the image carrier.

### SUMMARY

Multiple image forming units that form images by attaching developers onto surfaces of image carriers and transfer the images onto recording media may now be contemplated. The image forming units include a first image forming unit that forms an image of a developer of a first color on a surface of a first image carrier and a second image forming unit that is located downstream of the first image forming unit, forms an image of a developer of second color on a surface of a second image carrier and includes a contact member having a tip portion that contacts the surface of the second image carrier after the transferring. If the developer of the first color becomes powder deposits at the tip portion of the contact member, the deposits may fall onto the recording medium and image quality may be degraded.

Aspects of non-limiting embodiments of the present disclosure relate to controlling degradation in image quality in comparison with the case where the aggregation of a developer of a first color to powder deposits at a tip portion of a contact member that contacts the surface of a second image carrier after a transfer operation of the second image carrier is not controlled in a second image forming unit that is located downstream of a first image forming unit forming an image of the developer of the first color and includes the second image carrier that forms an image of a developer of a second color.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including multiple image forming units that are arranged in one direction and form images by attaching developers to surfaces of image carriers and transfer the images onto recording media, the image forming units including a first image forming unit that forms an image of a developer of a first color on a surface of a first image carrier and a second image forming unit that is located downstream of the first image forming unit, forms an image of a developer of second color on a surface of a second image carrier and includes a contact member having a tip portion that contacts the surface of the second image carrier after the transferring, wherein the image forming apparatus performs at a predetermined frequency an operation that forms a predetermined image by attaching the developer of the second color to the surface of the second image carrier and causes the predetermined image on the surface of the second image carrier to pass between the surface of the second image carrier after the transferring and the tip portion of the contact member.

### BRIEF DESCRIPTION OF THE DRAWINGS

Exemplary embodiment of the present disclosure will be described in detail based on the following figures, wherein:

FIG. 1 illustrates an image forming apparatus;

FIG. 2 illustrates a developing part in the image forming apparatus;

FIG. 3 illustrates the surroundings of a photoconductor drum of the image forming apparatus;

FIG. 4 illustrates the hardware configuration of a controller in the image forming apparatus;

FIG. 5 is a block diagram illustrating a functional configuration of the controller;

FIG. 6 illustrates an example of an image used in a breaking operation;

FIG. 7 illustrates the breaking operation performed using an image;

FIG. 8 is a flowchart illustrating an example of the procedure of the breaking operation; and

FIGS. 9A and 9B illustrate tables of the breaking operation of each image forming unit wherein FIG. 9A illustrates a frequency of the breaking operation and FIG. 9B illustrates the number of band-like portions of the image.

### DETAILED DESCRIPTION

Exemplary embodiment of the disclosure is described below in detail with reference to the drawings.

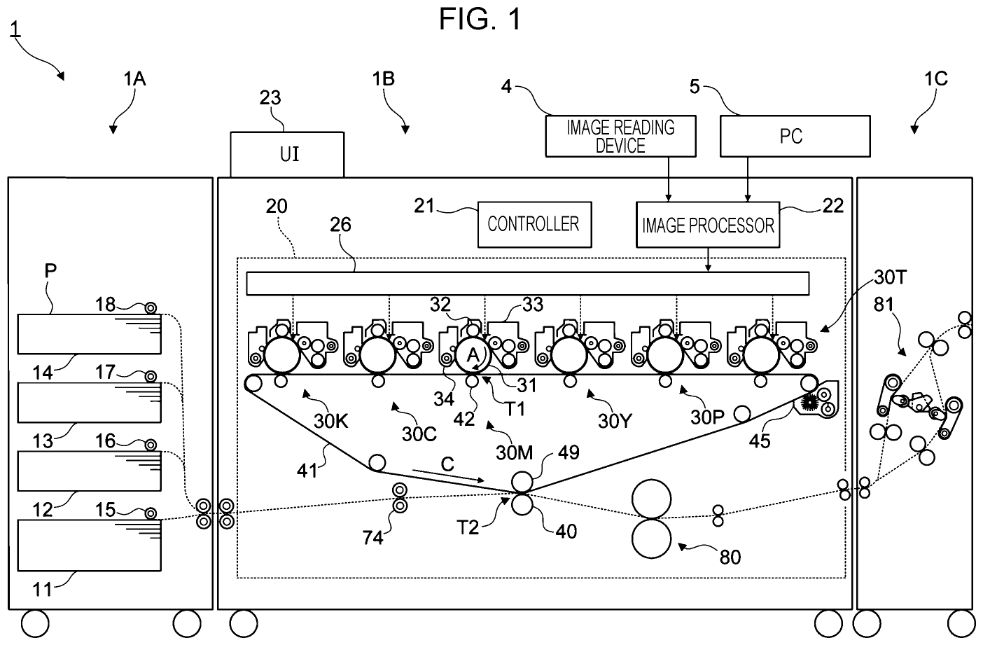

FIG. 1 illustrates an image forming apparatus 1.

The image forming apparatus 1 of the exemplary embodiment includes a paper feeder module 1A, printing module 1B and copy receiving module 1C.

The paper feeder module 1A includes first paper trays 11 through fourth paper tray 14 containing paper sheets P serving as an example of a recording medium.

The paper feeder module 1A includes paper feed rollers 15 through 18 that are respectively arranged for the first paper tray 11 through fourth paper tray 14 and feed paper sheets P contained in the paper trays to a transport path connected to the printing module 1B.

The printing module 1B includes an image former 20 that forms an image on a paper sheet P. The printing module 1B also includes a controller 21 that controls elements of the image forming apparatus 1.

The printing module 1B includes an image processor 22. The image processor 22 performs image processing on image data transmitted from an image reading device 4 or a personal computer (PC) 5.

The printing module 1B includes a touch panel and a user interface (UI) 23 that notifies a user of information and receives information from the user.

The image former 20 includes six image forming units 30T, 30P, 30Y, 30M, 30C and 30K (hereinafter occasionally simply referred to as an “image forming unit 30”) that are arranged in parallel with fixed space intervals therebetween.

Each image forming unit 30 includes a photoconductor drum 31 that rotates in the direction denoted by an arrow A with a latent image being formed thereon, charging roller 32 that charges the surface of the photoconductor drum 31, developing part 33 that develops an image from the latent image formed on the photoconductor drum 31 and a drum cleaner 34 that removes toner and the like from the surface of the photoconductor drum 31.

The image former 20 also includes a laser exposure device 26 that exposes to laser light the photoconductor drum 31 of each image forming unit 30.

The light exposure of the photoconductor drum 31 using the laser exposure device 26 is not limited to laser light. For example, each image forming unit 30 may include a light source, such as a light emitting diode (LED), and the photoconductor drum 31 may be exposed to light emitted from the light source.

The image forming units 30 are identical in configuration to each other except toner contained in the developing part 33. The image forming units 30Y, 30M, 30C and 30K respectively form yellow (Y), magenta (M), cyan (C) and black (K) toner images.

The image forming units 30T and 30P form toner images using toner corresponding to a corporate color, foaming toner for braille, fluorescent toner and toner enhancing gloss. In other words, the image forming units 30T and 30P form toner images using special color toner.

The image forming units 30T and 30P are examples of first image forming units that form images of developers of first colors on surfaces of first image carriers and the image forming units 30Y, 30M, 30C and 30K are examples of second image forming units that are located downstream of the first image forming units and form images of developers of second colors on surfaces of second image carriers. Specifically, the photoconductor drum 31 of each of the image forming units 30T and 30P is an example of a first image carrier and the developers of the first colors are the developers of the image forming units 30T and 30P. The photoconductor drum 31 of each of the image forming units 30Y, 30M, 30C and 30K is an example of a second image carrier, and the developers of the second colors are developers of the image forming units 30Y, 30M, 30C and 30K.

The image former 20 also includes an intermediate transfer belt 41 to which the toner images of the colors formed on the photoconductor drums 31 of the image forming units 30 are transferred.

The image former 20 further includes first transfer rollers 42 that transfer the toner images of the colors of the image forming units 30 to the intermediate transfer belt 41 at first transfer sections T1.

The image former 20 further includes a second transfer roller 40 that transfers at a time a toner image on the intermediate transfer belt 41 to the paper sheet P at a second transfer section T2.

The image former 20 further includes a belt cleaner 45 that removes the toner and the like on the surface of the intermediate transfer belt 41 and a fixing device 80 that fixes the second-transferred image onto the paper sheet P.

The image former 20 performs an image forming operation in accordance with a control signal from the controller 21.

Specifically, in the image former 20, the image processor 22 performs the image processing operation on image data input from the image reading device 4 or PC 5 and supplies the processed image data to the laser exposure device 26.

For example, with the surface of the photoconductor drum 31 in the magenta (M) image forming unit 30M charged with the charging roller 32, the laser exposure device 26 irradiates the photoconductor drum 31 with image-data-modulated laser light that is received from the image processor 22.

A latent image is thus formed on the photoconductor drum 31.

The developing part 33 develops from the latent image a magenta toner image on the photoconductor drum 31 and the magenta toner image is thus formed.

Similarly, yellow, cyan and black toner images are respectively formed on the image forming units 30Y, 30C and 30K and the special color toner images are formed on the image forming units 30T and 30P.

The toner images formed on the image forming units 30 are successively electrostatically transferred to the intermediate transfer belt 41 moving in the direction of the arrow C in FIG. 1 by the first transfer rollers 42, leading to a toner image superimposed on the intermediate transfer belt 41.

With the intermediate transfer belt 41 moving, the toner image superimposed on the intermediate transfer belt 41 is transported to the second transfer section T2 including the second transfer roller 40 and backup roller 49.

The paper sheet P is picked up, for example, from the first paper tray 11 by a feeder roller 15 and then transported along the transport path to the position of a paper stop roller 74.

When the superimposed toner image reaches the second transfer section T2, the paper sheet P is transported to the second transfer section T2 from the paper stop roller 74.

The effect of a transfer electric field created at the second transfer section T2 between the second transfer roller 40 and backup roller 49 causes the superimposed toner image to be electrostatically transferred to the paper sheet P.

The paper sheet P having the superimposed toner image transferred thereto is transported to the fixing device 80.

The fixing device 80 presses and heats the paper sheet P having the unfixed toner image, thereby performing a fixing operation to fix the toner image onto the paper sheet P.

The paper sheet P having undergone the fixing operation is transported via a curl correction section 81 in the copy receiving module 1C and then discharged into a paper receiving tray (not illustrated).

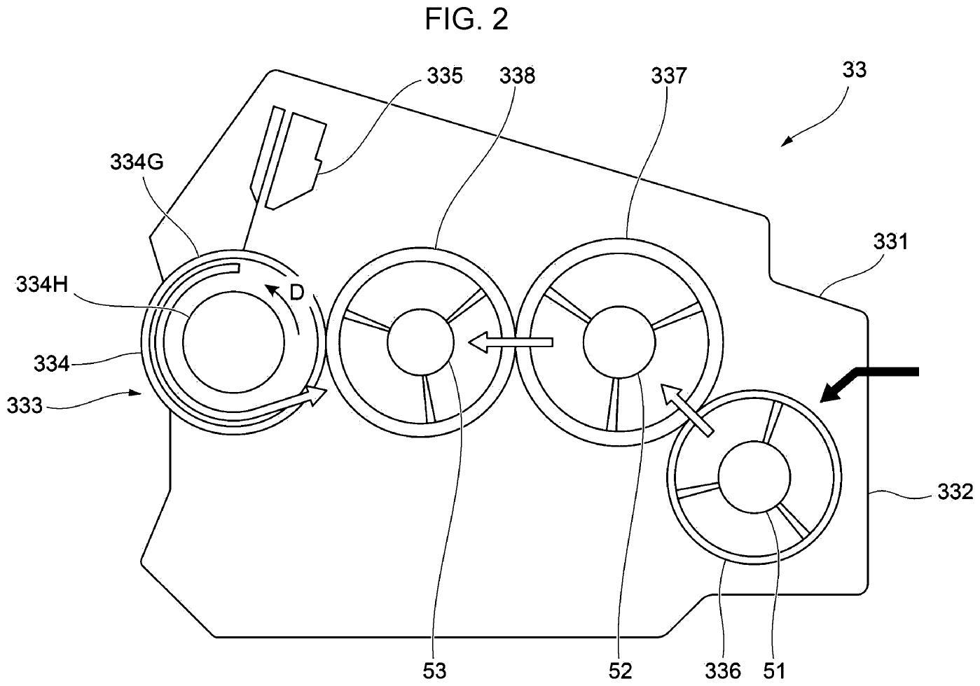

FIG. 2 is a side view of the developing part 33 of the image forming apparatus 1 viewed from the same direction as FIG. 1 is viewed.

Referring to FIG. 2, the developing part 33 includes a container 331 containing developer (not illustrated). The container 331 includes a container housing 332 that is manufactured of resin. The developer is a two-component developer including magnetic carrier and color toner. The developer may be a one-component developer.

A container body 332 of the developing part 33 is arranged to extend in a direction perpendicular to the plane of the page of FIG. 2, namely in a direction from a front side to a rear side of the image forming apparatus 1 (see FIG. 1), and includes a front-side member (not illustrated) on the front side and a rear-side member (not illustrated) on the rear side.

The container body 332 includes an opening 333 at a location facing the photoconductor drum 31 (see FIG. 1). A developing roller 334 that causes the developer to stick to the surface of the photoconductor drum 31 is arranged in the opening 333. The developing roller 334 holds the developer that is to be applied to the photoconductor drum 31. A position where the developer of the developing roller 334 is supplied to the photoconductor drum 31 may be referred to as a developing position.

The developing roller 334 is cylindrical and arranged to extend in the direction from the front side to the rear side of the image forming apparatus 1. In other words, the developing roller 334 is arranged to extend in the longitudinal direction of the developing part 33.

The developing roller 334 includes a developing sleeve 334G that is a cylindrical body and performs rotary drive and a magnetic roller 334H arranged inside the developing sleeve 334G.

The developing sleeve 334G is manufactured of, for example, stainless used steel (SUS). The developing sleeve 334G rotates in the direction denoted by the arrow D.

According to the exemplary embodiment, the developing sleeve 334G and the photoconductor drum 31 rotate in a synchronous direction at the first transfer section T1 (see FIG. 1) between the developing roller 334 and the photoconductor drum 31.

The developing part 33 includes a layer thickness regulating member 335 that regulates a thickness of the developer held by the developing roller 334.

Referring to FIG. 2, the developing part 33 includes first transport unit 336, second transport unit 337 and third transport unit 338 that transport the developer. In the following discussion, the first transport unit 336, second transport unit 337 and third transport unit 338 may also respectively referred to transport units 336-338.

The transport units 336-338 are arranged on the opposite side of the developing roller 334 with respect to the photoconductor drum 31 (see FIG. 1).

The transport units 336-338 have respectively rotary members 51, 52 and 53 that extend along an axis of rotation of the developing sleeve 334G that performs rotary drive and the transport units 336-338 thus respectively rotate on the rotary members 51-53. The transport units 336-338 are thus arranged in parallel with the photoconductor drum 31 (see FIG. 1).

Rotational speeds of the developing roller 334 and the rotary members 51-53 in each developing part 33 when a special color toner image is formed by the image forming unit 30 or when the special color toner image is not formed by the image forming unit 30 are described below. The rotational speed of the rotary members 51-53 may also be referred to as the speed of the transport units 336-338.

The exemplary embodiment is further described below.

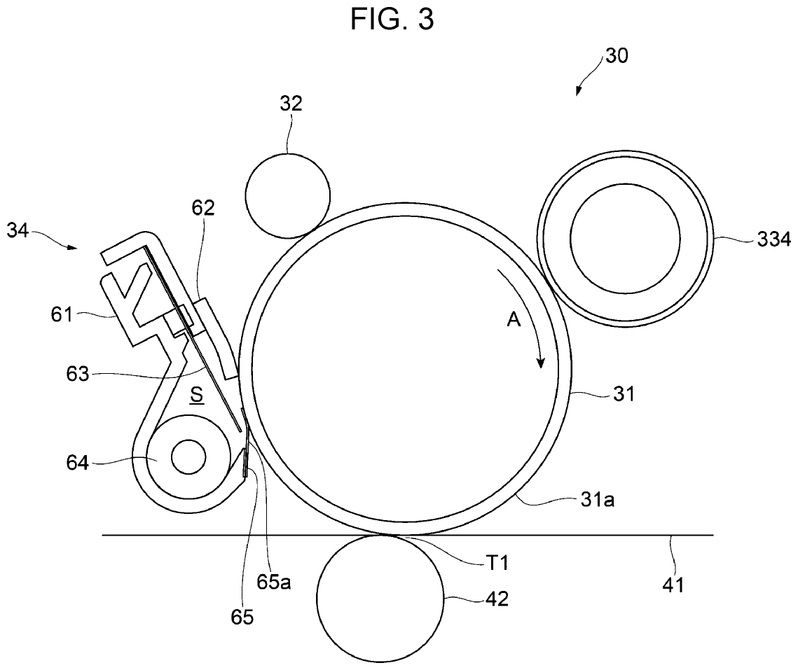

FIG. 3 illustrates the surroundings of the photoconductor drum 31 of the image forming apparatus 1. The photoconductor drum 31 illustrated in FIG. 3 is included in each of the image forming units 30.

Arranged around the photoconductor drum 31 in a direction denoted by the arrow A are the charging roller 32, developing roller 334, first transfer roller 42 and drum cleaner 34.

The drum cleaner 34 cleans the surface 31a of the photoconductor drum 31 at a location downstream of the first transfer section T1 in the direction denoted by the arrow A, thereby removing the toner and the like remaining on the surface 31a after the transferring. The drum cleaner 34 also collects the removed matter.

The drum cleaner 34 includes a housing 61, blade 62, partitioning member 63, transport member 64 and contact member 65.

The housing 61 secures the blade 62 and the like.

The blade 62 is mounted on the housing 61 such that the blade 62 is extended in an inclined direction opposite to the arrow A direction with respect the surface 31a of the photoconductor drum 31 and the blade 62 thus cleans the surface 31a with the tip thereof.

The partitioning member 63 is located between the housing 61 and the surface 31a of the photoconductor drum 31 and forms a space S that contains matter removed by the blade 62.

The transport member 64 is mounted in the space S and extends along the axis of rotation of the photoconductor drum 31. The transport member 64 rotates, transporting the removed matter. In this way, the removed matter is thus collected.

The contact member 65 is located to cover a gap between the housing 61 and the partitioning member 63 and forms the space S with the partitioning member 63.

The contact member 65 extends from the housing 61 to the surface 31a of the photoconductor drum 31.

Furthermore, one end portion of the contact member 65 is secured to the housing 61 such that the contact member 65 extends at an inclination with respect to the arrow A direction, a tip portion 65a as the other end portion of the contact member 65 is in contact with the surface 31a and part of the tip portion 65a is, for example, deformed along the surface 31a.

Toner and the like are divided between toner and the like that pass through between the tip portion 65a of the contact member 65 and the surface 31a of the photoconductor drum 31 and toner and the like that do not pass through between the tip portion 65a of the contact member 65 and the surface 31a of the photoconductor drum 31. Specifically, on a per image forming unit 30 basis, the quality of material of and thickness of the contact member 65 and the gap between the tip portion 65a and the surface 31a may be set depending on a condition, such as the size of toner particles supplied from the developing roller 334 to the photoconductor drum 31.

In this way, the toner and the like of the photoconductor drum 31 remaining on the surface 31a after the transferring pass through between the surface 31a and the tip portion 65a of the contact member 65 and then move to the position of the blade 62. On the other hand, the removed matter housed in the space S is restricted from moving out of the housing 61.

The contact member 65 of the exemplary embodiment may be manufactured of, for example, soft resin film.

According to the exemplary embodiment, from among the image forming units arranged in one direction, namely, the direction denoted by the arrow C (see FIG. 1) of the intermediate transfer belt 41, the image forming units 30T and 30P using the special colors, are arranged on a downstream side of the intermediate transfer belt 41 (see FIG. 1). The image forming units 30Y, 30M, 30C and 30K using respectively the YMCK colors are arranged downstream of the image forming units 30T and 30P (see FIG. 1). In view of the situation that a transparent recording medium, such as a cel, is viewed from back, a special color toner image may be formed at the most upstream location.

The special color toner particles are larger in particle size than the YMCK color toner particles. In the image forming units 30T and 30P, toner particles having a larger particle size may pass through between the surface 31a of the photoconductor drum 31 and the tip portion 65a of the contact member 65 and housed in the space S. On the other hand, in the image forming units 30Y, 30M, 30C and 30K, toner particles having a smaller particle size may pass through between the surface 31a and the tip portion 65a and housed in the space S while toner particles having a larger particle size are restricted from passing through between the surface 31a and the tip portion 65a.

In the image forming units 30Y, 30M, 30C and 30K when the special color toner of the image forming units 30T and 30P from the upstream side sticks to the surface 31a of the photoconductor drum 31 via the intermediate transfer belt 41, the special color toner particles may fail to pass through between the surface 31a and the tip portion 65a and may be deposited at the tip portion 65a.

The toner particles of the YMCK colors are almost spherical but the toner particles of the special colors may be different from a spherical form in comparison with the YMCK toner particles and the special color toner particles are likely to be deposited, leading to clumps. Each clump is likely to fall with its own weight from the tip portion 65a and, for example, the clumps falling on the intermediate transfer belt 41 may degrade image quality.

To control toner clumps from being created when the special color toner is deposited at the contact member 65, the exemplary embodiment performs a breaking operation that breaks the toner clumps at the contact member 65. The breaking operation is intended to remove the special color toner from the tip portion 65a and may be performed in the state in which the special color toner sticks to the contact member 65, in other words, may be performed before the state in which the special color toner is deposited.

The breaking operation is specifically described below. The breaking operation is an example of operation that passes an image on a surface between the surface after the transferring and the tip portion of the contact member.

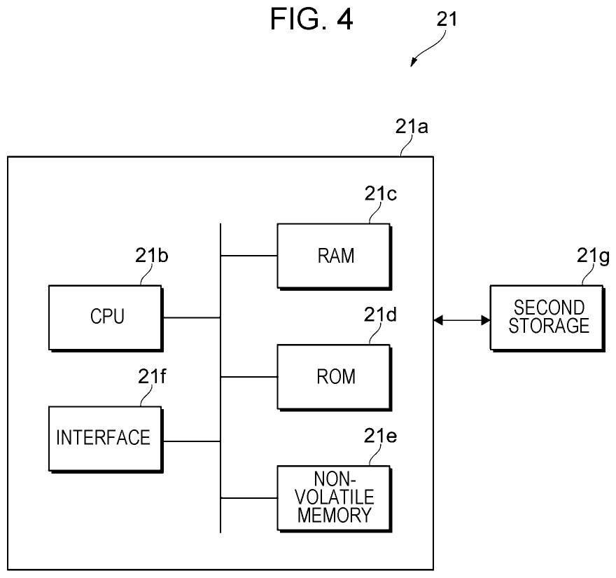

FIG. 4 illustrates a hardware configuration of the controller 21 in the image forming apparatus 1. The controller 21 in the image forming apparatus 1 is implemented by a computer.

The controller 21 includes an arithmetic processing unit 21a that performs a digital arithmetic processing operation in accordance with a program and a second storage 21g that stores information.

The second storage 21g may be an available information storage device, such as a hard disk drive (HDD), semiconductor memory or magnetic tape.

The arithmetic processing unit 21a includes a central processing unit (CPU) 21b as a processor.

The arithmetic processing unit 21a also includes a random-access memory (RAM) 21c that is used as a working memory for the CPU 21b and read-only memory (ROM) 21d that stores a program and the like executed by the CPU 21b.

The arithmetic processing unit 21a further includes a non-volatile memory 21e that is configured to be re-writable and continues to store data even when power supplying is interrupted and an interface 21f that controls a communication unit connected to the arithmetic processing unit 21a.

The non-volatile memory 21e includes, for example, a SRAM backed up by a battery or a flash memory. The second storage 21g stores not only files but also a program executed by the arithmetic processing unit 21a.

According to the exemplary embodiment, the arithmetic processing unit 21a performs operations by reading programs stored on the ROM 21d or the second storage 21g.

The programs to be executed by the CPU 21b may be delivered to the image forming apparatus 1 in a recorded form on one of computer readable recording media including a magnetic recording medium (such as a magnetic tape or magnetic disk), optical recording medium (such as an optical disk), magneto-optical recording medium or semiconductor memory. The programs to be executed by the CPU 21b may also be delivered to the image forming apparatus 1 using a communication medium, such as the Internet.

In the exemplary embodiment, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment, the term “processor” is broad enough to encompass one processor or plural processors in collaboration which are located physically apart from each other but may work cooperatively. The order of operations of the processor is not limited to one described in the exemplary embodiment herein, and may be changed.

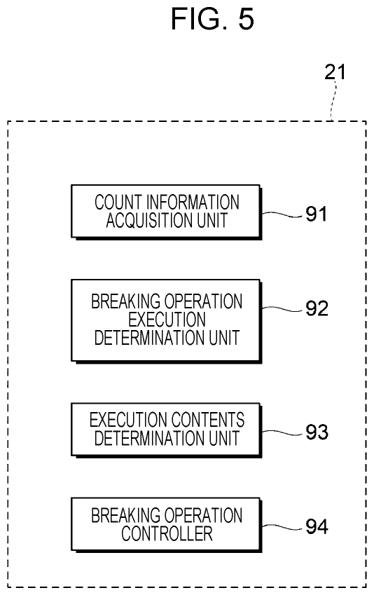

FIG. 5 is a block diagram illustrating a functional configuration of the controller 21.

The controller 21 illustrated in FIG. 5 includes a count information acquisition unit 91, breaking operation execution determination unit 92, execution contents determination unit 93 and breaking operation controller 94. The count information acquisition unit 91 and the other elements herein are implemented by the CPU 21b (see FIG. 4).

The count information acquisition unit 91 acquires count information indicating the number of times of printing that is performed using the special color toner of the image forming units 30T and 30P. The count information indicates the number of times of printing after the breaking operation is performed. The count information acquisition unit 91 is an example of a function of acquiring the number of times by which the first image forming unit has formed the image of developer of the first color.

The breaking operation execution determination unit 92 determines in accordance with the count information acquired by the count information acquisition unit 91 whether the breaking operation is to be performed on the image forming units 30Y, 30M, 30C and 30K.

The breaking operation is performed at a predetermined frequency. A determination as to whether execution time of the breaking operation has come is made depending on whether the acquired count information reaches a value corresponding to the predetermined frequency.

Furthermore, the breaking operation may be performed at a time on the image forming units 30Y, 30M, 30C and 30K or on an individual basis on the image forming units 30Y, 30M, 30C and 30K. If the breaking operation is performed at a time, the determination of the execution time of the breaking operation may be performed on one of the image forming units 30Y, 30M, 30C and 30K, for example, may be performed on the image forming unit 30Y. If the breaking operation is performed on an individual basis, the determination of the execution time of the breaking operation may be performed on each of the image forming units 30Y, 30M, 30C and 30K.

When the breaking operation execution determination unit 92 determines that the breaking operation is to be performed, the execution contents determination unit 93 determines execution contents that are to be performed as the breaking operation. The execution contents may be shared by the image forming units 30Y, 30M, 30C and 30K or may be different from image forming unit to image forming unit.

The breaking operation controller 94 controls the breaking operation to match the execution contents determined by the execution contents determination unit 93. Such control operation forms a toner image matching the determined execution contents onto the surface 31a of the photoconductor drum 31 (see FIG. 3) and causes the toner image to pass through between the surface 31a and the tip portion 65a (see FIG. 3) of the contact member 65 without being transferred to the intermediate transfer belt 41 (see FIG. 3) at the first transfer section T1 (see FIG. 3). The breaking operation controller 94 is an example of a function performing an operation.

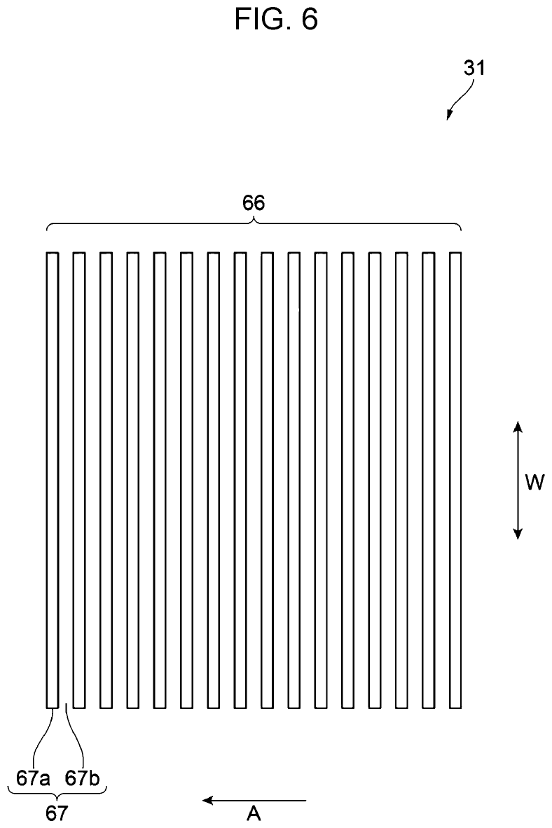

FIG. 6 illustrates an example of an image 66 used in the breaking operation. The image 66 is a toner image matching the execution contents determined by the execution contents determination unit 93 (see FIG. 5).

Referring to FIG. 6, the image 66 includes a toner image of band-like portions 67a that extend in a width direction W of the photoconductor drum 31 and are arranged in an arrow A direction. Specifically, the image 66 illustrated in FIG. 6 includes multiple unit segments 67, each including a band-like portion 67a.

The unit segment 67 includes a band-like portion 67a and a blank portion 67b between the band-like portion 67a and the adjacent band-like portion 67a.

The band-like portion 67a of the unit segment 67 has a length of, for example, 2 mm in the arrow A direction and the gap between the band-like portions 67a is, for example, 2 mm. The blank portion 67b thus has a length of 2 mm in the arrow A direction.

The image 66 is an example of a predetermined image. The width direction W of the photoconductor drum 31 is an example of an axial direction of a second image carrier and the arrow A direction is an example of a direction perpendicular to the axial direction. The band-like portion 67a is an example of a developer portion and the blank portion 67b is an example of a non-developer portion.

For example, the band-like portion 67a has a density of 80%, an overall width of 300 mm in the width direction W and a length of 2 mm in the arrow A direction.

For example, the image 66 may include 30 unit segments 67 arranged in the arrow A direction.

The values of the density, length in the width direction W, length in the arrow A direction and number of unit segments 67 are described for exemplary purposes only and different values may be used. Furthermore, the values may be different from image forming unit to image forming unit among the image forming units 30Y, 30M, 30C and 30K.

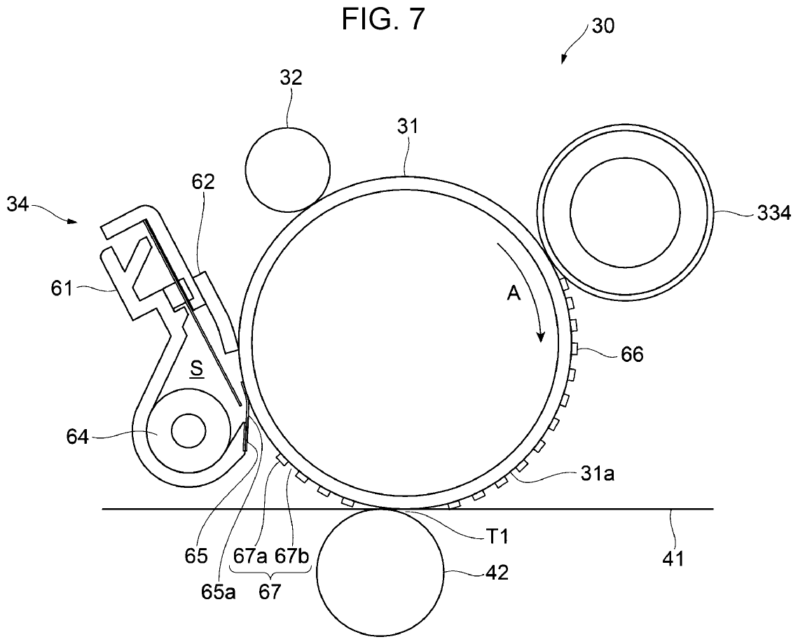

FIG. 7 illustrates the breaking operation performed using the image 66.

When the image 66 is formed on the surface 31a of the photoconductor drum 31 as illustrated in FIG. 7, a transfer potential is controlled such that the image 66 is not transferred at the first transfer section T1. In this way, the image 66 on the surface 31a, after passing the first transfer section T1, stays on the surface 31a and passes by the tip portion 65a of the contact member 65.

Furthermore, when the image 66 on the surface 31a passes by the tip portion 65a of the contact member 65, the contact member 65 contacts a repetitive concave-convex pattern of the image 66 and thus vibrates. Specifically, when the band-like portion 67a of the image 66 pass by the tip portion 65a, the gap between the surface 31a and the tip portion 65a widens and after the band-like portion 67a passes, the tip portion 65a returns to the original shape thereof. The motion of the tip portion 65a may be repeated when the next band-like portion 67a passes. This motion is thus repeated by the number of band-like portions 67a. The motion affects not only the tip portion 65a but also the other portion of the contact member 65.

The contact member 65 thus vibrates in the motion, removing the special color toner from the contact member 65.

The image 66 is formed over the entire width to cause the contact member 65 to vibrate over the entire width length of the contact member 65.

With the contact member 65 vibrating, the special color toner present at the contact member 65 is separated from the contact member 65. The vibration expands the gap between the surface 31a and the contact member 65, causing the special color toner separated from the contact member 65 and sticking to the surface 31a to be more easily drawn into the space S.

The image 66 on the surface 31a is removed by the blade 62, placed into the space S and collected together with the special color toner by the transport member 64.

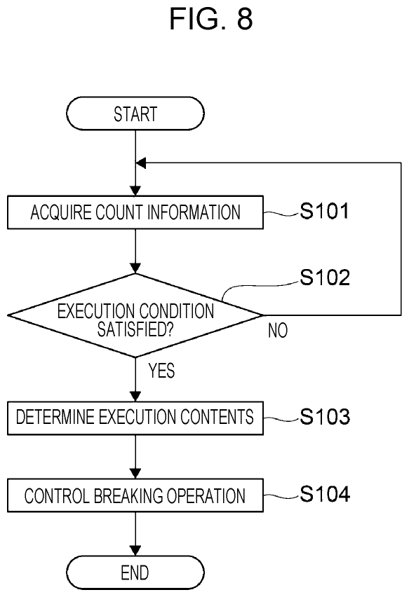

FIG. 8 is a flowchart illustrating an example of the procedure of the breaking operation.

Referring to FIG. 8, the count information acquisition unit 91 acquires the count information (step S101) and the breaking operation execution determination unit 92 (see FIG. 5) determines whether the acquired count information satisfies a predetermined execution condition (step S102).

The execution condition is that a determination as to whether time to perform the breaking operation has come is made by, for example, referring to the number of times specified in the acquired count information. For example, the execution condition is information on a predetermined frequency described below. For example, the predetermined frequency is once every 200 times, and the execution condition is related to whether the number of times specified in the count information reaches 200 times or not.

The execution condition may be varied in response to the type of special color toner, such as white, golden, silver or the like of the image forming units 30T and 30P or may remain the same regardless of the type of the special color toner of the image forming units 30T and 30P.

The execution condition may remain the same regardless of amounts of use of special color toner on the image forming units 30T and 30P or may be changed in response to the amounts of use of the special color toner on the image forming units 30T and 30P. For example, the execution condition is controlled by modifying the frequency in accordance with information indicating an image density that is an amount of toner per unit area calculated on a per print job basis. Specifically, the frequency is increased in response to a higher image density and decreased in response to a lower image density.

The information indicating the image density of the special color may be acquired by the count information acquisition unit 91 in the controller 21 (see FIG. 5) and is reflected in the determination of the execution condition (see step S102 in FIG. 8). The information indicating the image density of the special color is an example of the information indicating the amount of use of the developer of the first color.

If multiple image forming units containing toner of special colors of, such as the image forming units 30T and 30P, are used in the exemplary embodiment, a sum with the amount of use of each special color added to is calculated and the execution condition may be varied in response to the sum.

If the acquired count information satisfies the predetermined execution condition (yes in step S102), the execution contents determination unit 93 (see FIG. 5) determines the execution contents of the breaking operation (step S103).

If the predetermined execution condition is not satisfied (no in step S102), processing returns to step S101.

The execution contents of the breaking operation may be the number of band-like portions 67a in the image 66 (see FIG. 6).

The execution contents may be different from unit to unit among the image forming units 30Y, 30M, 30C and 30K or may remain the same on the image forming units 30Y, 30M, 30C and 30K.

The breaking operation controller 94 (see FIG. 5) then performs control on the breaking operation in accordance with the determined the execution contents. In this way, the breaking operation is periodically performed.

Such control may include inserting the image 66 (see FIG. 6) when the photoconductor drum 31 is rotating in the print job. Specifically, the execution timing of the breaking operation is, for example, when the image 66 is formed between one print image and the next print image or when the image 66 is formed after the last image is formed.

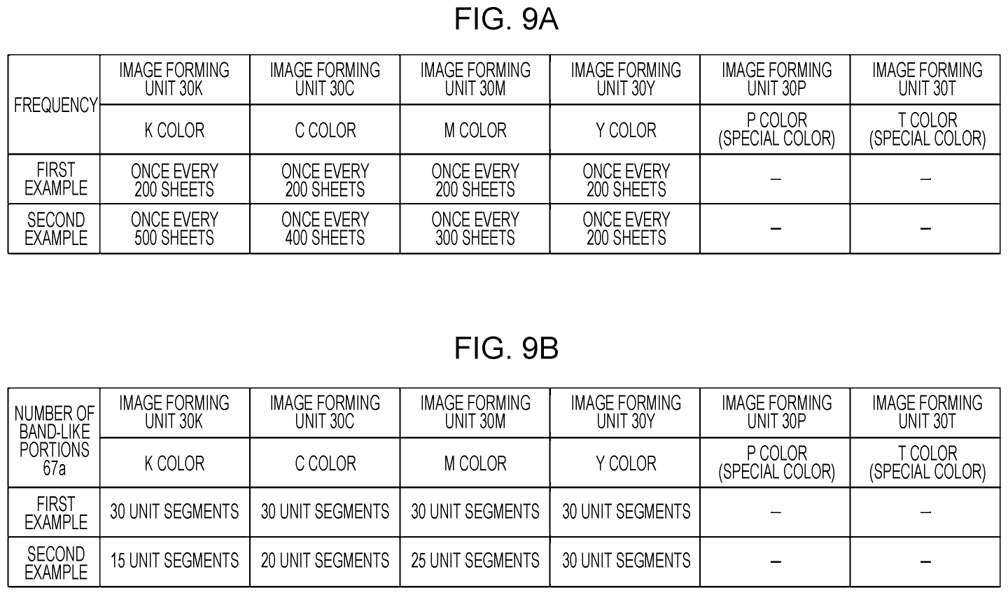

FIGS. 9A and 9B illustrate tables of the breaking operation of each image forming unit 30 wherein FIG. 9A illustrates a frequency of the breaking operation and FIG. 9B illustrates the number of band-like portions 67a of the image 66. The number of band-like portions 67a also refers to the number of unit segments 67 (see FIG. 6).

The frequency illustrated in FIG. 9A is an example of the predetermined frequency and the number of band-like portions 67a illustrated in FIG. 9B is an example of the number of developer portions.

The frequencies illustrated in FIG. 9A indicate per how many sheets the breaking operation is to be performed on each of the image forming units 30Y, 30M, 30C and 30K when printing using special color toner is performed on the paper sheet P on the image forming units 30T and 30P. In such a case, the size of the paper sheet P (see FIG. 1) to be printed may be, for example, sheet size A4 and if another sheet size is used, size conversion to the sheet size A4 may be performed.

In a first example of the frequency illustrated in FIG. 9A, the breaking operation is performed at a frequency of “once every 200 sheets” on each of the image forming units 30Y, 30M, 30C and 30K. Specifically, the breaking operation is performed at the same frequency on the image forming units 30Y, 30M, 30C and 30K. In this case, “200 sheets” correspond to a value corresponding to the predetermined frequency.

In a second example of the frequency, the amount of the special color toner of each image forming unit is smaller as the image forming unit is located more downstream and the breaking operation is thus performed at frequencies different from the frequencies in the first example. Specifically, the image forming unit 30Y has a frequency of “once every 200 sheets,” the image forming unit 30M has a frequency of “once every 300 sheets,” the image forming unit 30C has a frequency of “once every 400 sheets” and the image forming unit 30K has a frequency of “once every 500 sheets.” In the second example of the frequencies, the frequency of each of the image forming units 30Y, 30M, 30C and 30K is reduced as the image forming unit is located more downstream.

Specifically, the image forming unit 30Y closer to the image forming units 30T and 30P has the highest frequency and the image forming unit 30K farthest from the image forming units 30T and 30P has the lowest frequency. The frequency is set in accordance with the distance from the image forming units 30T and 30P. In other words, the image forming unit 30Y being closer to the image forming units 30T and 30P and thus having the largest amount of the special color toner that has arrived has the highest frequency. The image forming unit 30K being farther from the image forming units 30T and 30P and thus having the smallest amount of the special color toner that has arrived has the lower frequency.

The frequency of the breaking operation of each image forming unit is reduced as the distance of the image forming unit from the image forming units 30T and 30P increases in the arrow C direction of the intermediate transfer belt 41 (see FIG. 1). As the frequency becomes higher, an amount of toner consumption increases and as the frequency becomes lower, the amount of toner consumption is more restricted. In the second example in view of the first example, the second example may restrict the amount of toner consumption of the YMCK colors and may preclude the special color toner deposited at the tip portion 65a of the contact member 65 (see FIG. 6) from becoming larger toner clumps.

Control of the image forming units 30M, 30C and 30K with the breaking operation performed on only the image forming unit 30Y in the second example is described below. In such a case, the image 66 is formed on the image forming unit 30Y while the same image 66 as formed on the image forming unit 30Y is not formed on the other image forming units 30M, 30C and 30K. However, the control operation may be contemplated to form images, the number of which (for example, one image) is smaller than the number of band-like portions 67a of the image 66 on the image forming unit 30Y in order to restrict wear of the blade 62 (see FIG. 3) on each of the image forming units 30M, 30C and 30K.

The number of band-like portions 67a illustrated in FIG. 9B is the number of band-like portions 67a included in the image 66 (see FIG. 6). As the number becomes higher, a time length throughout which the tip portion 65a of the contact member 65 (see FIG. 6) vibrates becomes longer and the special color toner may be reliably removed from the tip portion 65a.

In the first example illustrated in FIG. 9B, the breaking operation is performed using the image 66 having 30 band-like portions 67a on each of the image forming units 30Y, 30M, 30C and 30K.

On the other hand, in the second example, 30 band-like portions 67a are used on the image forming unit 30Y, 25 band-like portions 67a are used on the image forming unit 30M, 20 band-like portions 67a are used on the image forming unit 30C and 15 band-like portions 67a are used on the image forming unit 30K.

The number of band-like portions 67a is set to be smaller as the distance from the image forming units 30T and 30P increases in the arrow C direction of the intermediate transfer belt 41. In the second example in view of the first example, the second example may restrict the amount of toner consumption of the YMCK colors and may preclude the special color toner deposited at the tip portion 65a of the contact member 65 (see FIG. 6) from becoming larger toner clumps.

Referring to FIGS. 9A and 9B, the breaking operation is not performed on the image forming units 30T and 30P. Alternatively, the breaking operation may also be performed on the image forming units 30T and 30P.

According to the exemplary embodiment, the image forming apparatus 1 includes the image forming units 30Y, 30M, 30C and 30K forming the images of the YMCK colors and the image forming units 30T and 30P forming the images of the special colors. The disclosure is not limited to this arrangement. For example, the image forming apparatus 1 may include a subset of the image forming units 30Y, 30M, 30C and 30K, for example, only the image forming unit 30K. The image forming apparatus 1 may include only one of the image forming units 30T and 30P.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming apparatus including multiple image forming units that are arranged in one direction and form images by attaching developers to surfaces of image carriers and transfer the images onto recording media, the image forming units including a first image forming unit that forms an image of a developer of a first color on a surface of a first image carrier and a second image forming unit that is located downstream of the first image forming unit, forms an image of a developer of second color on a surface of a second image carrier and includes a contact member having a tip portion that contacts the surface of the second image carrier after the transferring,

wherein the image forming apparatus performs at a predetermined frequency an operation that forms a predetermined image by attaching the developer of the second color to the surface of the second image carrier and causes the predetermined image on the surface of the second image carrier to pass between the surface of the second image carrier after the transferring and the tip portion of the contact member.
(((2)))

In the image forming apparatus according to (((1))), the image forming units include the multiple second image forming units that form images of developers of yellow, magenta, cyan and black (YMCK) colors as the developers of the second colors.
(((3)))

In the image forming apparatus according to (((2))), the predetermined frequencies are respectively set on the second image forming units.
(((4)))

In the image forming apparatus according to (((3))), the predetermined frequencies of the second image forming units are set to be lower as the second image forming units are located more downstream.
(((5)))

In the image forming apparatus according to (((3))), the setting of the predetermined frequencies is performed in accordance with information indicating an amount of use of the developer of the first color.
(((6)))

In the image forming apparatus according to one of (((1))) through (((5))), the predetermined image includes a developer portion that extends in an axial direction of the second image carrier and a non-developer portion that is arranged between the developer portions that are spaced apart in a direction perpendicular to the axial direction.
(((7)))

In the image forming apparatus according to (((6))), if the image forming units include the multiple second image forming units, the number of the developer portions is reduced in each of the second image forming units as the second image forming unit is located more downstream.
(((8)))

In the image forming apparatus according to one of (((1))) through (((7))), the first image forming unit does not form the predetermined image.
(((9)))

A program causing a processor to execute a process, the processor controlling an image forming apparatus including multiple image forming units that are arranged in one direction and form images by attaching developers to surfaces of image carriers and transfer the images onto recording media, the image forming units including a first image forming unit that forms an image of a developer of a first color on a surface of a first image carrier and a second image forming unit that is located downstream of the first image forming unit, forms an image of a developer of second color on a surface of a second image carrier and includes a contact member having a tip portion that contacts the surface of the second image carrier after the transferring, the processor configured to perform:
a function of acquiring a count by which the first image forming unit has formed the images of the developer of the first color; and
if the acquired count satisfies a predetermined condition, a function of performing at a predetermined frequency an operation that forms a predetermined image by attaching the developer of the second color to the surface of the second image carrier and causes the predetermined image on the surface of the second image carrier to pass between the surface of the second image carrier after the transferring and the tip portion of the contact member.

What is claimed is:

1. An image forming apparatus comprising a plurality of image forming units that are arranged in one direction and form images by attaching developers to surfaces of image carriers and transfer the images onto recording media, the image forming units including a first image forming unit that forms an image of a developer of a first color on a surface of a first image carrier and a second image forming unit that is located downstream of the first image forming unit, forms an image of a developer of second color on a surface of a second image carrier and includes a contact member having a tip portion that contacts the surface of the second image carrier after the transferring,
wherein the image forming apparatus performs at a predetermined frequency an operation that forms a predetermined image by attaching the developer of the second color to the surface of the second image carrier and causes the predetermined image on the surface of the second image carrier to pass between the surface of the second image carrier after the transferring and the tip portion of the contact member.

2. The image forming apparatus according to claim 1, wherein the image forming units comprise a plurality of the second image forming units that form images of developers of yellow, magenta, cyan and black (YMCK) colors as the developers of the second colors.

3. The image forming apparatus according to claim 2, wherein the predetermined frequencies are respectively set on the second image forming units.

4. The image forming apparatus according to claim 3, wherein the predetermined frequencies of the second image forming units are set to be lower as the second image forming units are located more downstream.

5. The image forming apparatus according to claim 3, wherein the setting of the predetermined frequencies is performed in accordance with information indicating an amount of use of the developer of the first color.

6. The image forming apparatus according to claim 1, wherein the predetermined image comprises a developer portion that extends in an axial direction of the second image carrier and a non-developer portion that is arranged between the developer portions that are spaced apart in a direction perpendicular to the axial direction.

7. The image forming apparatus according to claim 6, wherein if the image forming units comprise a plurality of the second image forming units, a number of the developer portions is reduced in each of the second image forming units as the second image forming unit is located more downstream.

8. The image forming apparatus according to claim 1, wherein the first image forming unit does not form the predetermined image.

9. A non-transitory computer readable medium storing a program causing a computer to execute a process, the computer controlling an image forming apparatus including a plurality of image forming units that are arranged in one direction and form images by attaching developers to surfaces of image carriers and transfer the images onto recording media, the image forming units including a first image forming unit that forms an image of a developer of a first color on a surface of a first image carrier and a second image forming unit that is located downstream of the first image forming unit, forms an image of a developer of second color on a surface of a second image carrier and includes a contact member having a tip portion that contacts the surface of the second image carrier after the transferring, the process comprising:
acquiring a count by which the first image forming unit has formed the images of the developer of the first color; and
if the acquired count satisfies a predetermined condition, performing at a predetermined frequency an operation that forms a predetermined image by attaching the developer of the second color to the surface of the second image carrier and causes the predetermined image on the surface of the second image carrier to pass between the surface of the second image carrier after the transferring and the tip portion of the contact member.

10. An image forming method of an image forming apparatus including a plurality of image forming units that are arranged in one direction and form images by attaching developers to surfaces of image carriers and transfer the images onto recording media, the image forming units including a first image forming unit that forms an image of a developer of a first color on a surface of a first image carrier and a second image forming unit that is located downstream of the first image forming unit, forms an image of a developer of second color on a surface of a second image carrier and includes a contact member having a tip portion that contacts the surface of the second image carrier after the transferring, the image forming method comprising:
acquiring a count by which the first image forming unit has formed the images of the developer of the first color; and
if the acquired count satisfies a predetermined condition, performing at a predetermined frequency an operation that forms a predetermined image by attaching the developer of the second color to the surface of the second image carrier and causes the predetermined image on the surface of the second image carrier to pass between the surface of the second image carrier after the transferring and the tip portion of the contact member.
